(19) United States
(12) Patent Application Publication
(10) Pub. No.: US 2008/0195381 A1
(43) Pub. Date: Aug. 14, 2008

(54) Line Spectrum pair density modeling for speech applications

(75) Inventors: Frank Kao-Ping Soong, Warren, NJ (US); Yao Qian, Beijing (CN)

Correspondence Address: WESTMAN CHAMPLIN (MICROSOFT CORPORATION), SUITE 1400, 900 SECOND AVENUE SOUTH, MINNEAPOLIS, MN, 55402-3244, US

(73) Assignee: Microsoft Corporation, Redmond, WA (US)

(21) Appl. No.: 11/704,522

(22) Filed: Feb. 9, 2007

(51) Int. Cl. G10L 11/00

(52) U.S. Cl. 704/200

(57) ABSTRACT

Novel techniques for providing superior performance and sound quality in speech applications, such as speech synthesis, speech coding, and automatic speech recognition, are hereby disclosed. In one illustrative embodiment, a method includes modeling a speech signal with parameters comprising line spectrum pairs. Density parameters are provided based on the density of the line spectrum pairs. A speech application output, such as synthesized speech, is provided based at least in part on the line spectrum pair density parameters. The line spectrum pair density parameters use computing resources efficiently while providing improved performance and sound quality in the speech application output.

### BACKGROUND

Modeling speech signals for applications such as automatic speech synthesis, speech coding, automatic speech recognition, and so forth, has been an active field of research. Speech synthesis is the artificial production of human speech. A computing system used for this purpose serves as a speech synthesizer, and may be implemented in a variety of hardware and software embodiments. This may be part of a text-to-speech system, that takes text and converts it into synthesized speech.

One established framework for a variety of applications, such as automatic speech synthesis and automatic speech recognition, is based on pattern models known as hidden Markov models (HMMs), which provide state space models with latent variables describing interconnected states, for modeling data with sequential patterns. Units of a speech signal, such as phones, may be associated with one or more states of the pattern models. Typically, the pattern models incorporate classification parameters that must be trained to correspond accurately to a speech signal. However, it remains a challenge to effectively model speech signals, to achieve goals such as a synthesized speech signal that is easier to understand and more like natural human speech.

The discussion above is merely provided for general background information and is not intended to be used as an aid in determining the scope of the claimed subject matter.

### SUMMARY

Novel techniques for providing superior performance and sound quality in speech applications, such as speech synthesis, speech coding, and automatic speech recognition, are hereby disclosed. In one illustrative embodiment, a method includes modeling a speech signal with parameters comprising line spectrum pairs. Density parameters are provided based on the density of the line spectrum pairs. A speech application output, such as synthesized speech, is provided based at least in part on the line spectrum pair density parameters. The line spectrum pair density parameters use computing resources efficiently while providing improved performance and sound quality in the speech application output.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

FIG. 1 depicts a block diagram schematic of an automatic speech synthesis system, according to an illustrative embodiment.

FIG. 2 depicts a flow diagram of an automatic speech synthesis method, according to an illustrative embodiment.

FIG. 3 depicts a representation of a power spectrum for a speech signal showing line spectrum pair density used for modeling the speech signal, according to an illustrative embodiment.

FIG. 4 depicts a block diagram of a general computing environment in which various embodiments may be practiced, according to an illustrative embodiment.

FIG. 5 depicts a block diagram of a computing environment in which various embodiments may be practiced, according to another illustrative embodiment.

### DETAILED DESCRIPTION

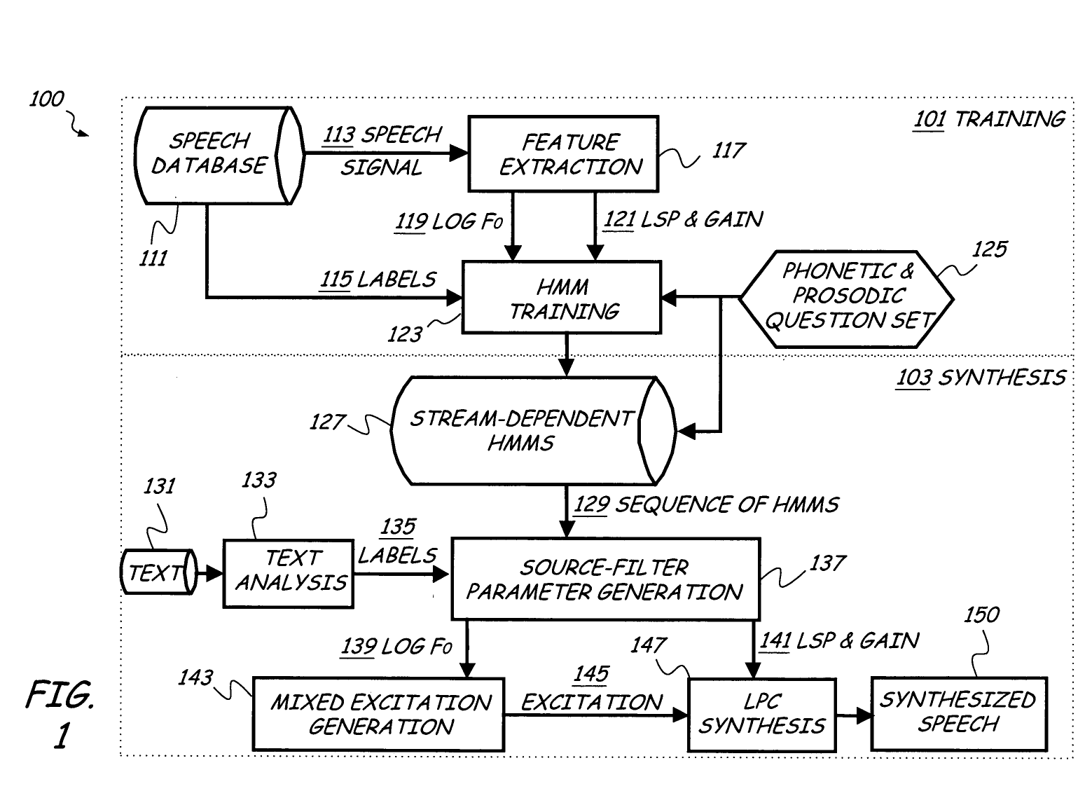

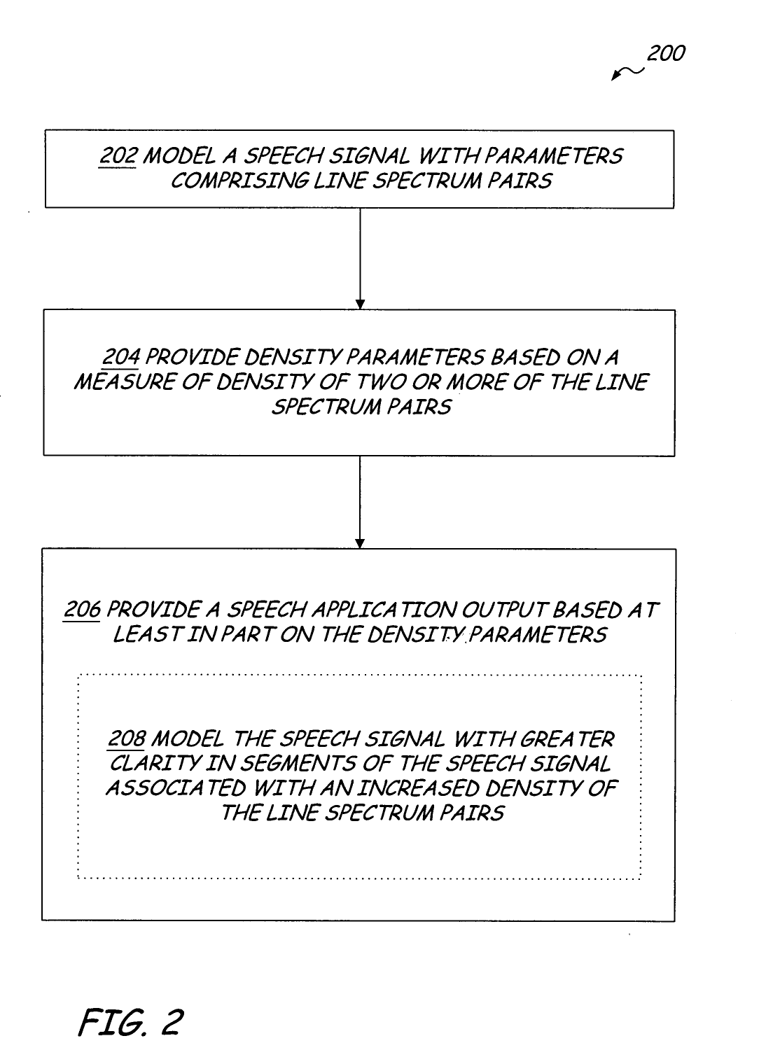

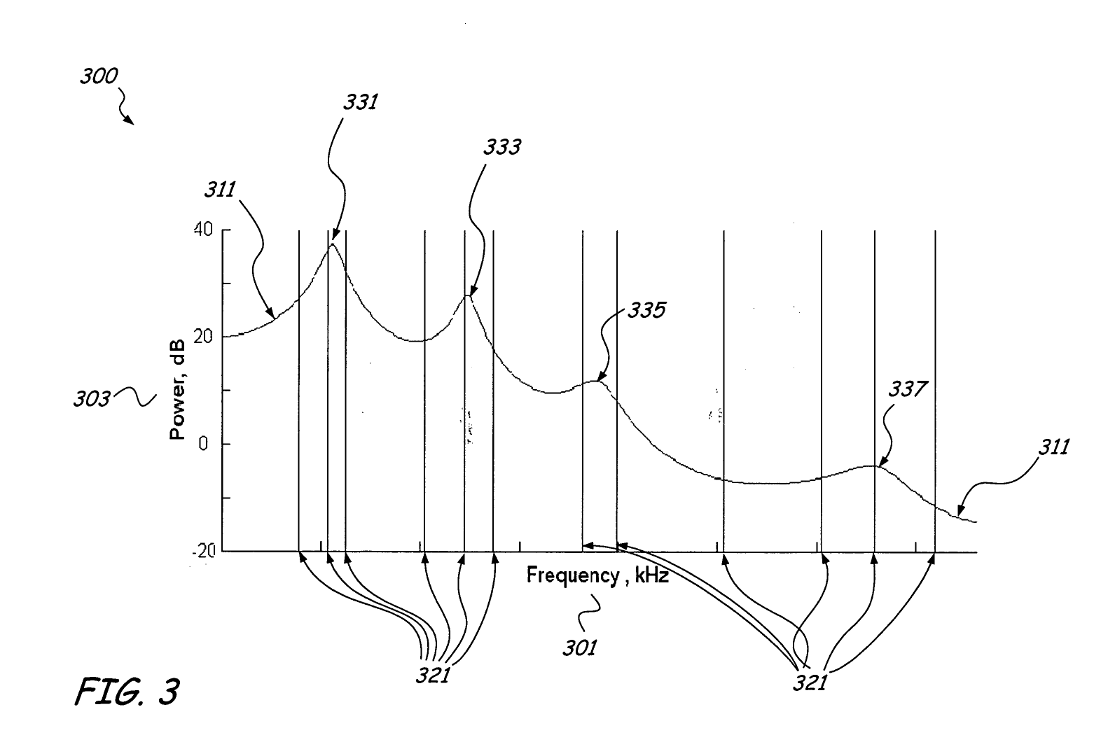

FIG. 1 depicts a block diagram schematic of an automatic speech synthesis system 100, according to an illustrative embodiment. Automatic speech synthesis system 100 may be implemented in any of a wide variety of software and/or hardware embodiments, an illustrative survey of which are detailed herein. FIG. 2 provides a flow diagram of an illustrative automatic speech synthesis method 200 that may illustratively be used in connection with the automatic speech synthesis system 100 of FIG. 1, in an exemplary embodiment. FIG. 3 depicts a representation of a power spectrum for a speech signal showing line spectrum pair (LSP) density used for modeling the speech signal, according to an illustrative embodiment. These embodiments describe an automatic speech synthesis application as an instructive example from among a much broader array of embodiments dealing with various speech applications, which also include speech coding and automatic speech recognition, but are also not limited to any of these particular examples.

According to one illustrative embodiment, in hidden Markov model (HMM)-based speech synthesis, a speech signal is provided that emulates the sound of natural human speech. The speech signal includes a speech frequency spectrum representing voiced vibrations of a speaker's vocal tract. It includes information content such as a fundamental frequency F₀ (representing vocal fold or source information content), duration of various signal portions, patterns of pitch, gain or loudness, voiced/unvoiced distinctions, and potentially any other information content needed to provide a speech signal that emulates natural human speech, although different embodiments are not limited to including any combination of these forms of information content in a speech signal. Any or all of these forms of signal information content can be modeled simultaneously with hidden Markov modeling, or any of various other forms of modeling a speech signal.

A speech signal may be based on waveforms generated from a set of hidden Markov models, based on a universal, maximum likelihood function. HMM-based speech synthesis using line spectrum pair density parameters may be statistics-based and vocoded, and generate a smooth, natural-sounding speech signal. Characteristics of the synthetic speech can easily be controlled by transforming HMM modeling parameters, which may be done with a statistically tractable metric such as a likelihood function. HMM-based speech synthesis using line spectrum pair density parameters combines high clarity in the speech signal with efficient usage of computing resources, such as RAM, processing time, and bandwidth, and is therefore well-suited for a variety of implementations, including those for mobile and small devices.

FIG. 1 depicts a schematic diagram of a hidden Markov model (HMM)-based automatic speech synthesis system 100, according to one illustrative embodiment. Automatic speech synthesis system 100 includes both a training portion 101, and a synthesis portion 103. Automatic speech synthesis system 100 is provided here to illustrate various features that may also be embodied in a broad variety of other implementations, which are not limited to any of the particular details provided in this illustrative example.

In the training phase 101, a speech signal 113 from a speech database 111 is converted to a sequence of observed feature vectors through the feature extraction module 117, and modeled by a corresponding sequence of HMMs in HMM training module 123. The observed feature vectors may consist of spectral parameters and excitation parameters, which are separated into different streams. The spectral features 121 may comprise line spectrum pair (LSP) and log gain, and the excitation feature 119 may comprise a logarithm of fundamental frequency F₀. LSPs may be modeled by continuous HMMs and fundamental frequencies F₀ may be modeled by multi-space probability distribution HMM (MSD-HMM), which provides a cogent modeling of F₀ without any heuristic assumptions or interpolations. Context-dependent phone models may be used to capture the phonetic and prosody co-articulation phenomena 125. State typing based on decision-tree and minimum description length (MDL) criterion may be applied to overcome any problem of data sparseness in training. Stream-dependent HMM models 127 may be built to cluster the spectral, prosodic and duration features into separated decision trees.

In the synthesis phase, input text 131 may be converted first into a sequence of contextual labels through the text analysis module 133. The corresponding contextual HMMs 129 may be retrieved by traversing the trees of spectral and pitch information and the duration of each state is also obtained by traversing the duration tree, then the LSP, gain and F₀ trajectories 141, 139 may be generated by using the parameter generation algorithm 137 based on maximum likelihood criterion with dynamic feature and global variance constraints. The fundamental frequency F₀ trajectory and corresponding statistical voiced/unvoiced information can be used to generate mixed excitation parameters 145 with the generation module 143. Finally, speech waveform 150 may be synthesized from the generated spectral and excitation parameters 141, 145 by LPC synthesis module 147.

A broad variety of different options can be used to implement automatic speech synthesis system 100. Illustrative examples of some of the various implementing options are provided hereby as examples, while these are understood not to imply limitation from other embodiments. For example, a speech corpus may be recorded by a single speaker to provide speech database 111, with training data composed of a relatively large number of phonetically and prosodically rich sentences. A smaller number of sentences may be used for testing data. A speech signal may be sampled at any of a variety of selected rates; in one illustrative embodiment it may be sampled at 16 kilohertz, windowed by a 25 millisecond window with a five millisecond shift, although higher and lower sampling frequencies, and window and shift times, or other timing parameters than this may also be used. These may be transformed into any of a broad range of LSPs counts; in one illustrative embodiment, 24th-order LSPs may be used, or 40th-order in another, or other numbers of LSPs above and below these values. For example, the order of LSPs, the speech sample frame sizes, and other gradations of the speech signal data and modeling parameters may be suited to the level of resources, such as RAM, processing speed, and bandwidth, that are to be available in a computing device used to implement the automatic speech synthesis system 100. An implementation with a server in contact with a client machine may use more intensive and higher performance options, such as a shorter signal frame length and higher LSP order, while the opposite may be true for a base-level mobile device or cellphone handset, in various illustrative embodiments.

FIG. 2 depicts a flowchart for a method 200 that may be used in connection with automatic speech synthesis system 100, in one exemplary embodiment, without implying any limitations from other embodiments. Method 200 includes step 202, of modeling a speech signal with parameters comprising line spectrum pairs; step 204, of providing density parameters based on a measure of density of two or more of the line spectrum pairs; and step 206, of providing a speech application output based at least in part on the density parameters. Step 206 may also include step 208, of modeling the speech signal with greater clarity in segments of the speech signal associated with an increased density of the line spectrum pairs.

FIG. 3 depicts a representation of a linear predictive coding (LPC) power spectrum 300 for one frame of a speech signal, showing line spectrum pair (LSP) density used for modeling the speech signal, according to an illustrative embodiment. Power spectrum 300 provides a measure of the power 303 of a speech signal 311, along the y-axis, as a function of the frequencies 301 within the speech signal 311, along the x-axis. Speech signal 311 has been modeled, such as by an algorithm, with parameters comprising a fixed number of frequencies for line spectrum pairs (LSPs) 321, in this illustrative embodiment. While this depiction has been simplified for clarity, other embodiments may model speech signal 311 with a larger number of line spectrum pairs, such as 24 line spectrum pairs, or 40 line spectrum pairs, for example. Other embodiments may use any number of line spectrum pairs for modeling a speech signal. Generally, using more line spectrum pairs provides additional information about a speech signal and can provide superior sound quality, while using more line spectrum pairs also tends to use more computing resources.

Line spectrum pairs 321 provide a good, simple, salient indication of what portions of the frequency spectrum of the speech signal 311 correspond to the formants 331, 333, 335, 337. The formants, or dominant frequencies in a speech signal, are significantly more important to sound quality than the troughs in between them. This is particularly true of the lowest-frequency and highest-power formant, 331. The formants occupy portions of the frequency spectrum that have significantly higher power than their surrounding frequencies, and are therefore indicated as the peaks in the graphical curve representing the power as a function of frequency for the speech signal 311.

Because the line spectrum pairs 321 tend to cluster around the formants 331, 333, 335, 337, the positions of the line spectrum pairs 321 serve as effective and efficient indicators of the positions (in terms of portions of the frequency spectrum) of the formants. Furthermore, the density of the line spectrum pairs 321, in terms of the differences in their positions, with smaller spacing differences coinciding with higher densities, also provides perhaps an even more effective and efficient indicator of the frequencies and properties of the formants. By modeling the speech signal at least in part with parameters based on the density of the line spectrum pair frequencies, an automatic speech synthesis system, such as automatic speech synthesis system 100 of FIG. 1, may fine-tune the hidden Markov model parameters to achieve a high clarity reproduction or synthesis of the sounds of human speech.

Some of the advantages of using parameters based on line spectrum pairs and line spectrum pair density, are provided in further detail as follows in accordance with one illustrative embodiment, by way of example and not by limitation. Line spectrum pairs provide equivalent information as linear predictive coefficients (LPC), but with certain advantages that lend themselves well to interpolation, quantization, search techniques, and speech applications in particular. Line spectrum pairs can provide a more convenient parameterization of linear predictive coefficients by providing symmetric and antisymmetric polynomials that sum up to an arbitrary polynomial in the denominator of linear predictive coefficients.

In analyzing line spectrum pairs, a speech signal may be modeled as the output of an all-pole filter H(z) defined as:

$$H ( z ) = \frac{1}{A ( z )} = \frac{1}{1 - {\sum }_{i = 1}^{M} {a}_{i} {z}^{- i}} \qquad ( EQ . 1 )$$

where M is the order of linear predictive coefficient (LPC) analysis and {αᵢ}ᵢ₌₁^{M} are the corresponding LPC coefficients. The LPC coefficients can be represented by the LSP parameters, which are mathematically equivalent (one-to-one) and more amenable to quantization. The LSP parameters may be calculated with reference to the symmetric polynomial P(z) and antisymmetric polynomial Q(z) as follows:

P(z)=A(z)+z^{-(M+1)}A(z⁻¹) (EQ. 2)

Q(z)=A(z)−z^{-(M+1})A(z⁻¹) (EQ. 3)

The symmetric polynomial P(z) and anti-symmetric polynomial Q(z) have the following properties: all zeros of P(z) and Q(z) are on the unit circle, and the zeros of P(z) and Q(z) are interlaced with each other around the unit circle. These properties are useful for finding the LSPs {ωᵢ}ᵢ₌₁^{M}, i.e., the roots the polynomial P(z) and Q(z), which are ordered and bounded:

0<ω₁<ω₂< . . . <ω_{M}<π (EQ. 4)

LSP-based parameters have many advantages for speech representation. For example, LSP parameters correlate well to formant or spectral peak location and bandwidth. Referring again to FIG. 3, which is illustratively derived from a speech signal frame with a phone corresponding to the vowel sound /a/, the LPC power spectrum and the associated LSPs are shown, where clustered (two or three) LSPs depict a formant peak, in terms of both the center frequency and bandwidth.

As another advantage of LSP-based parameters, perturbation of an LSP parameter has a localized effect. That is, a perturbation in a given LSP frequency introduces a perturbation of LPC power spectrum mainly in the neighborhood of the perturbed LSP frequency, and does not significantly disturb the rest of the spectrum. As a further advantage, LSP-based parameters have good interpolation properties.

In the automatic speech synthesis system 100 depicted in FIG. 1, the speech parameter generation from a given HMM state sequence may be based on maximum likelihood function or criterion. In order to generate a smoother LSP parameter trajectory, C=[c₁^{T}, c₂^{T}, . . . , c_{T}^{T]}^{T}, dynamic features ΔC=[Δc₁^{T}, Δc₂^{T}, . . . , Δc_{T}^{T}]^{T} and Δ²C=[Δ²c₁^{T}, Δ²c₂^{T}, . . . , Δ²c_{T}^{T}]^{T} may be used as a constraint in the generation algorithm. For a given HMM λ, it may determine a speech parameter vector sequence:

O=[C,ΔC,Δ²C]^{T}, C=[c₁^{T},c₂^{T}, . . . , c_{T}^{T}]^{T},

ΔC=[Δc₁^{T},Δc₂^{T}, . . . , Δc_{T}^{T}]^{T}, Δ²C=[Δ²c₁^{T}, Δ²c₂^{T}, . . . , Δ²c_{T}^{T}]^{T}

which maximizes the probability for a speech parameter vector sequence O given the HMM λ, over a summation of state sequences Q:

$$P ( O \text{\textbar} λ ) = {\sum }_{all Q} P ( O , Q \text{\textbar} λ ) {•max}_{Q} P ( O \text{\textbar} Q , λ ) P ( Q \text{\textbar} λ ) \qquad ( EQ . 5 )$$

If given state sequence Q={q₁,q₂,q₃, . . . , q_{T}}, Eq. 5 only need consider maximizing the logarithm of the probability for a speech parameter vector sequence O given the state sequence Q and the HMM λ, P(O|Q,λ), with respect to speech parameter vector sequence O as a weighting matrix W applied to speech parameter C, O=WC, i.e.,

$$\frac{\partial Log P ( WC \text{\textbar} Q , λ )}{\partial C} = 0 \qquad ( EQ . 6 )$$

From this, we may obtain:

$$\begin{matrix}{W}^{T} {U}^{- 1} WC = {W}^{T} {U}^{- 1} M \\ i . e . \text{:} \\ C = {( {W}^{T} {U}^{- 1} W )}^{- 1} {W}^{T} {U}^{- 1} M \\ where \text{:} & ( EQ . 7 ) \\ [ \begin{matrix}1 & & & & \\ & ⋰ & & & \\ & & ⋰ & & \\ & & & ⋯ & \\ & & & & \\ & & & & \end{matrix} ] \} DT \\ W = [ \begin{matrix}{I}_{F} \\ {W}_{Δ F} \\ {W}_{ΔΔ F}\end{matrix} ] = [ \begin{matrix}0.5 & & & & \\ & ⋰ & & & \\ & & ⋰ & & \\ & & & ⋯ & \\ & & & & \\ & & & & \end{matrix} ] \} DT \\ \underbrace{[ \begin{matrix}1 & & & & \\ & ⋰ & & & \\ & & - 2 & & \\ & & & ⋰ & \\ & & & & ⋯ \\ & & & & \end{matrix} ]}_{DT} \} \} DT & ( EQ . 8 ) \\ M = {[ {m}_{{q}_{1}}^{T} , {m}_{{q}_{2}}^{T} , … , {m}_{{q}_{T}}^{T} ]}^{T} & ( EQ . 9 ) \\ {U}^{- 1} = diag [ {U}_{{q}_{1}}^{- 1} , {U}_{{q}_{2}}^{- 1} , … , {U}_{{q}_{T}}^{- 1} ] & ( EQ . 10 )\end{matrix}$$

where D is the dimension of feature vector and T is the total number of frame in the sentence. W is a block matrix which is composed of three DT×DT matrices: Identity matrix (I_{F}), delta coefficient matrix (W_{ΔF}), and delta-delta coefficient matrix (W_{ΔΔF}). M and U are the 3DT×1 mean vector and the 3DT×3DT covariance matrix, respectively.

As mentioned above, a gathering of (for example, two or three) LSPs depicts a formant frequency and the closeness of the corresponding LSPs indicates the magnitude and bandwidth of a given formant. Therefore, the differences between the adjacent LSPs, in terms of the density of the line spectrum pairs, provides advantages beyond the absolute values of the individual LSPs. On the other hand, all LSP frequencies are ordered and bounded, i.e. any two adjacent LSP trajectories do not cross each other. Using static and dynamic LSPs alone, in modeling and generation, may have difficulty ensuring the stability of LSPs. On the other hand, this may be resolved by providing line spectrum pair density parameters, such as by adding the differences of adjacent LSP frequencies directly into spectral parameter modeling and generation. The weighting matrix W, which is used to transform the observation feature vector, may be modified to provide line spectrum pair density parameters, as:

W=[I_{F}, W_{DF}, W_{ΔF}, W_{ΔF}W_{DF}, W_{ΔΔF}, W_{ΔΔF}W_{DF}] (EQ. 11)

where F is static LSP; DF is the difference between adjacent LSP frequencies; ΔF and ΔΔF are dynamic LSPs, i.e., first and second order time derivatives; and W_{DF} is (D−1)T×DT matrix and constructed as:

$${W}_{DF} = [ \begin{matrix}- 1 & 1 & & & & \\ & - 1 & 1 & & & \\ & & & ⋯ & & \\ & & & & ⋰ & \\ & & & & & \\ & & & & & \end{matrix} ] \qquad ( EQ . 12 )$$

In this way, diagonal covariance structure is kept the same, while the correlation and differences in frequency of adjacent LSPs can be modeled, and used to provide line spectrum pair density parameters, based on a measure of density of at least two or more of the line spectrum pairs. These line spectrum pair density parameters can then be used to provide speech application outputs, such as synthesized speech, with previously unavailable efficiency and sound clarity.

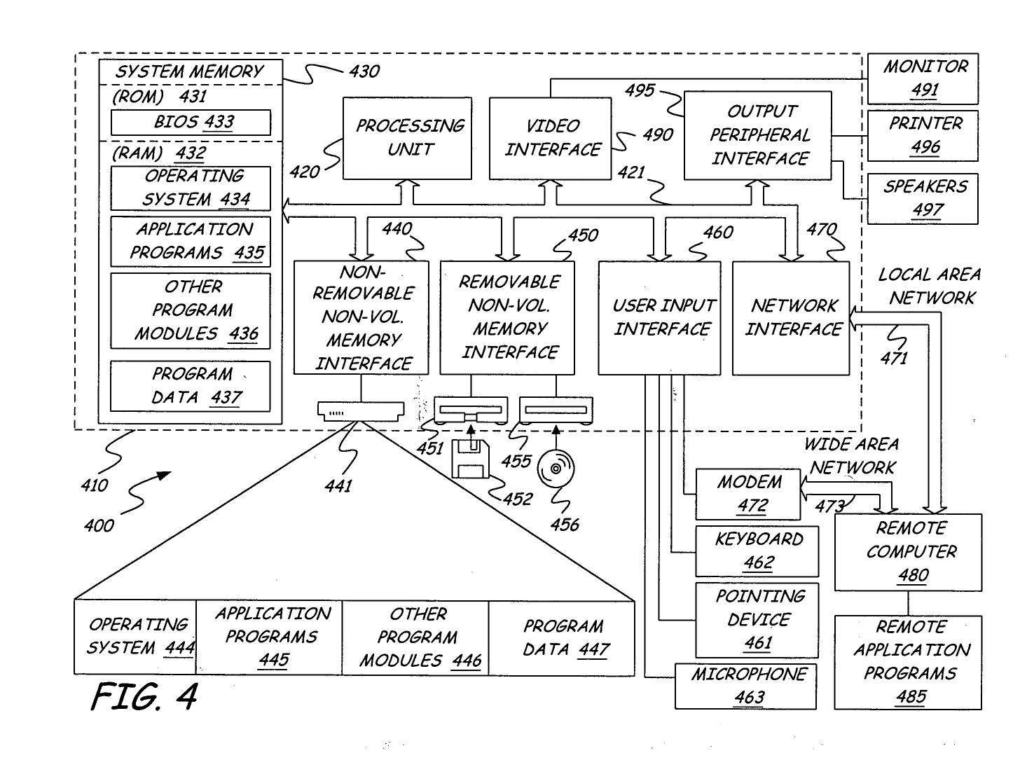

FIG. 4 illustrates an example of a suitable computing system environment 400 on which various embodiments may be implemented. For example, various embodiments may be implemented as software applications, modules, or other forms of instructions that are executable by computing system environment 400 and that configure computing system environment 400 to perform various tasks or methods involved in different embodiments. A software application or module associated with an illustrative implementation of a dynamic projected user interface may be developed in any of a variety of programming or scripting languages or environments. For example, it may be written in C#, F#, C++, C, Pascal, Visual Basic, Java, JavaScript, Delphi, Eiffel, Nemerle, Perl, PHP, Python, Ruby, Visual FoxPro, Lua, or any other programming language. It is also envisioned that new programming languages and other forms of creating executable instructions will continue to be developed, in which further embodiments may readily be developed.

Computing system environment 400 as depicted in FIG. 4 is only one example of a suitable computing environment for implementing various embodiments, and is not intended to suggest any limitation as to the scope of use or functionality of the claimed subject matter. Neither should the computing environment 400 be interpreted as having any dependency or requirement relating to any one or combination of components illustrated in the exemplary operating environment 400.

Embodiments are operational with numerous other general purpose or special purpose computing system environments or configurations. Examples of well-known computing systems, environments, and/or configurations that may be suitable for use with various embodiments include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

Embodiments may be described in the general context of computer-executable instructions, such as program modules, being executed by a computer. Generally, program modules include routines, programs, objects, components, data structures, etc. that perform particular tasks or implement particular abstract data types. Some embodiments are designed to be practiced in distributed computing environments where tasks are performed by remote processing devices that are linked through a communications network. In a distributed computing environment, program modules are located in both local and remote computer storage media including memory storage devices. As described herein, such executable instructions may be stored on a medium such that they are capable of being read and executed by one or more components of a computing system, thereby configuring the computing system with new capabilities.

With reference to FIG. 4, an exemplary system for implementing some embodiments includes a general-purpose computing device in the form of a computer 410. Components of computer 410 may include, but are not limited to, a processing unit 420, a system memory 430, and a system bus 421 that couples various system components including the system memory to the processing unit 420. The system bus 421 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 410 typically includes a variety of computer readable media. Computer readable media can be any available media that can be accessed by computer 410 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 410. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 430 includes computer storage media in the form of volatile and/or nonvolatile memory such as read only memory (ROM) 431 and random access memory (RAM) 432. A basic input/output system 433 (BIOS), containing the basic routines that help to transfer information between elements within computer 410, such as during start-up, is typically stored in ROM 431. RAM 432 typically contains data and/or program modules that are immediately accessible to and/or presently being operated on by processing unit 420. By way of example, and not limitation, FIG. 4 illustrates operating system 434, application programs 435, other program modules 436, and program data 437.

The computer 410 may also include other removable/non-removable volatile/nonvolatile computer storage media. By way of example only, FIG. 4 illustrates a hard disk drive 441 that reads from or writes to non-removable, nonvolatile magnetic media, a magnetic disk drive 451 that reads from or writes to a removable, nonvolatile magnetic disk 452, and an optical disk drive 455 that reads from or writes to a removable, nonvolatile optical disk 456 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 441 is typically connected to the system bus 421 through a non-removable memory interface such as interface 440, and magnetic disk drive 451 and optical disk drive 455 are typically connected to the system bus 421 by a removable memory interface, such as interface 450.

The drives and their associated computer storage media discussed above and illustrated in FIG. 4, provide storage of computer readable instructions, data structures, program modules and other data for the computer 410. In FIG. 4, for example, hard disk drive 441 is illustrated as storing operating system 444, application programs 445, other program modules 446, and program data 447. Note that these components can either be the same as or different from operating system 434, application programs 435, other program modules 436, and program data 437. Operating system 444, application programs 445, other program modules 446, and program data 447 are given different numbers here to illustrate that, at a minimum, they are different copies.

A user may enter commands and information into the computer 410 through input devices such as a keyboard 462, a microphone 463, and a pointing device 461, such as a mouse, trackball or touch pad. Other input devices (not shown) may include a joystick, game pad, satellite dish, scanner, or the like. These and other input devices are often connected to the processing unit 420 through a user input interface 460 that is coupled to the system bus, but may be connected by other interface and bus structures, such as a parallel port, game port or a universal serial bus (USB). A monitor 491 or other type of display device is also connected to the system bus 421 via an interface, such as a video interface 490. In addition to the monitor, computers may also include other peripheral output devices such as speakers 497 and printer 496, which may be connected through an output peripheral interface 495.

The computer 410 is operated in a networked environment using logical connections to one or more remote computers, such as a remote computer 480. The remote computer 480 may be a personal computer, a hand-held device, a server, a router, a network PC, a peer device or other common network node, and typically includes many or all of the elements described above relative to the computer 410. The logical connections depicted in FIG. 4 include a local area network (LAN) 471 and a wide area network (WAN) 473, but may also include other networks. Such networking environments are commonplace in offices, enterprise-wide computer networks, intranets and the Internet.

When used in a LAN networking environment, the computer 410 is connected to the LAN 471 through a network interface or adapter 470. When used in a WAN networking environment, the computer 410 typically includes a modem 472 or other means for establishing communications over the WAN 473, such as the Internet. The modem 472, which may be internal or external, may be connected to the system bus 421 via the user input interface 460, or other appropriate mechanism. In a networked environment, program modules depicted relative to the computer 410, or portions thereof, may be stored in the remote memory storage device. By way of example, and not limitation, FIG. 4 illustrates remote application programs 485 as residing on remote computer 480. It will be appreciated that the network connections shown are exemplary and other means of establishing a communications link between the computers may be used.

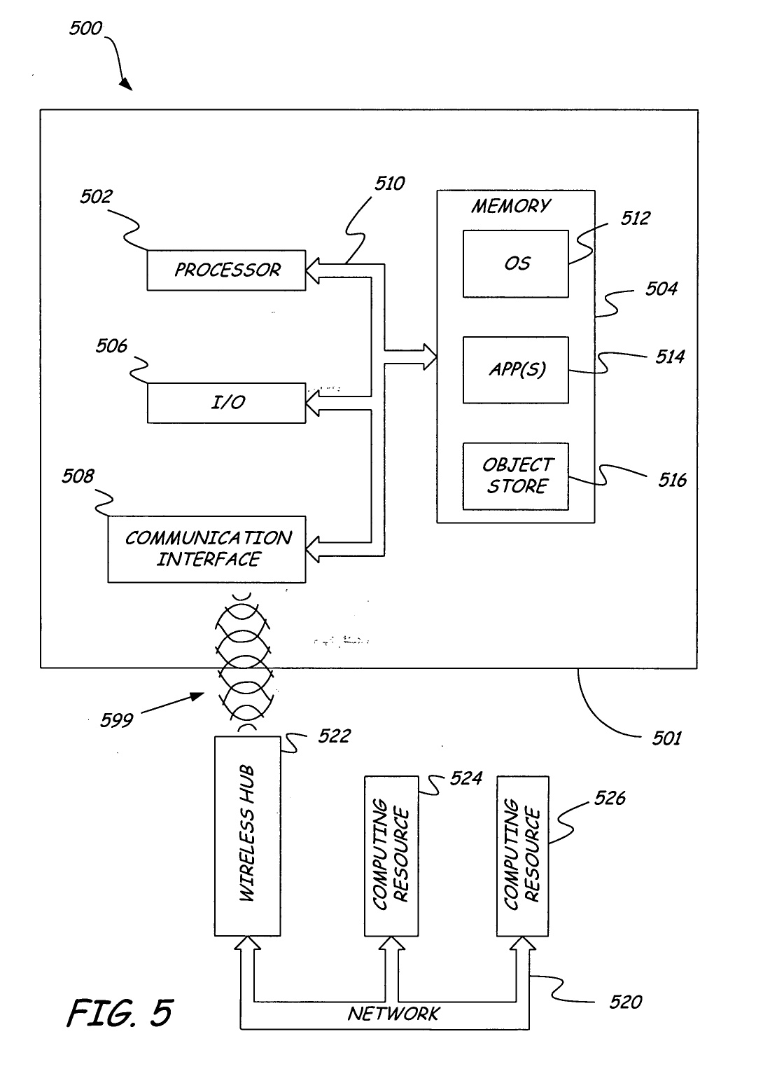

FIG. 5 depicts a block diagram of a general mobile computing environment, comprising a mobile computing device and a medium, readable by the mobile computing device and comprising executable instructions that are executable by the mobile computing device, according to another illustrative embodiment. FIG. 5 depicts a block diagram of a mobile computing system 500 including mobile device 501, according to an illustrative embodiment. Mobile device 501 includes a microprocessor 502, memory 504, input/output (I/O) components 506, and a communication interface 508 for communicating with remote computers or other mobile devices. In one embodiment, the afore-mentioned components are coupled for communication with one another over a suitable bus 510.

Memory 504 is implemented as non-volatile electronic memory such as random access memory (RAM) with a battery back-up module (not shown) such that information stored in memory 504 is not lost when the general power to mobile device 500 is shut down. A portion of memory 504 is illustratively allocated as addressable memory for program execution, while another portion of memory 504 is illustratively used for storage, such as to simulate storage on a disk drive.

Memory 504 includes an operating system 512, application programs 514 as well as an object store 516. During operation, operating system 512 is illustratively executed by processor 502 from memory 504. Operating system 512, in one illustrative embodiment, is a WINDOWS® CE brand operating system commercially available from Microsoft Corporation. Operating system 512 is illustratively designed for mobile devices, and implements database features that can be utilized by applications 514 through a set of exposed application programming interfaces and methods. The objects in object store 516 are maintained by applications 514 and operating system 512, at least partially in response to calls to the exposed application programming interfaces and methods.

Communication interface 508 represents numerous devices and technologies that allow mobile device 500 to send and receive information. The devices include wired and wireless modems, satellite receivers and broadcast tuners to name a few. Mobile device 500 can also be directly connected to a computer to exchange data therewith. In such cases, communication interface 508 can be an infrared transceiver or a serial or parallel communication connection, all of which are capable of transmitting streaming information.

Input/output components 506 include a variety of input devices such as a touch-sensitive screen, buttons, rollers, and a microphone as well as a variety of output devices including an audio generator, a vibrating device, and a display. The devices listed above are by way of example and need not all be present on mobile device 500. In addition, other input/output devices may be attached to or found with mobile device 500.

Mobile computing system 500 also includes network 520. Mobile computing device 501 is illustratively in wireless communication with network 520—which may be the Internet, a wide area network, or a local area network, for example—by sending and receiving electromagnetic signals 599 of a suitable protocol between communication interface 508 and wireless interface 522. Wireless interface 522 may be a wireless hub or cellular antenna, for example, or any other signal interface. Wireless interface 522 in turn provides access via network 520 to a wide array of additional computing resources, illustratively represented by computing resources 524 and 526. Naturally, any number of computing devices in any locations may be in communicative connection with network 520. Computing device 501 is enabled to make use of executable instructions stored on the media of memory component 504, such as executable instructions that enable computing device 501 to implement various functions of using line spectrum pair density modeling for automatic speech applications, in an illustrative embodiment.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims. As a particular example, while the terms “computer”, “computing device”, or “computing system” may herein sometimes be used alone for convenience, it is well understood that each of these could refer to any computing device, computing system, computing environment, mobile device, or other information processing component or context, and is not limited to any individual interpretation. As another particular example, while many embodiments are presented with illustrative elements that are widely familiar at the time of filing the patent application, it is envisioned that many new innovations in computing technology will affect elements of different embodiments, in such aspects as user interfaces, user input methods, computing environments, and computing methods, and that the elements defined by the claims may be embodied according to these and other innovative advances while still remaining consistent with and encompassed by the elements defined by the claims herein.

What is claimed is:

1. A method comprising:
modeling a speech signal with parameters comprising line spectrum pairs;
providing density parameters based on a measure of density of two or more of the line spectrum pairs; and
providing a speech application output based at least in part on the density parameters.

2. The method of claim 1, wherein providing the speech application output based at least in part on the density parameters comprises modeling the speech signal with greater clarity in segments of the speech signal associated with an increased density of the line spectrum pairs.

3. The method of claim 1, further providing dynamic parameters based at least in part on changes in the density of two or more of the line spectrum pairs, from one part of the speech signal to another, and providing the speech application output based at least in part on the dynamic parameters.

4. The method of claim 1, wherein the speech application output comprises an automatic speech synthesis output.

5. The method of claim 1, wherein the speech application output comprises a speech coding output.

6. The method of claim 1, wherein the speech application output comprises a speech recognition output.

7. The method of claim 1, wherein modeling the speech signal comprises using at least one hidden Markov model trained at least in part with the parameters comprising line spectrum pairs.

8. The method of claim 7, further comprising using a maximum likelihood function to determine the parameters.

9. The method of claim 1, wherein modeling the speech signal comprises converting the speech signal to a sequence of feature vectors, wherein the line spectrum pairs are comprised in the feature vectors.

10. The method of claim 1, further comprising providing dynamical density parameters based on a measure of changes in the density of two or more of the line spectrum pairs over time, and providing the speech application output based also at least in part on the dynamical density parameters.

11. The method of claim 1, further comprising selecting a fixed number of line spectrum pair frequencies per frame used for modeling the speech signal based at least in part on an evaluation of computing resources available for the modeling.

12. The method of claim 1, further comprising sharpening one or more formant frequencies prior to determining the line spectrum pairs.

13. The method of claim 1, wherein modeling the speech signal with parameters comprising line spectrum pairs, comprises transforming observation feature vectors extracted from the speech signal, using a block matrix that provides the observation feature vectors, differences between adjacent observation feature vectors, and rates of change in the difference between the adjacent observation feature vectors.

14. The method of claim 13, wherein providing the density parameters comprises modifying the block matrix to compare the observation feature vectors between two adjacent line spectrum pair frequencies, and using the comparison to evaluate a frequency difference between the two adjacent line spectrum pair frequencies.

15. The method of claim 1, wherein modeling the speech signal with parameters comprising line spectrum pairs and providing the density parameters based on the measure of density of the two or more of the line spectrum pairs, are performed by a training portion of a system, and providing the speech application output based at least in part on the density parameters is performed by a speech application output portion of a system.

16. The method of claim 1, further comprising using at least 24 line spectrum pairs for modeling the speech signal.

17. The method of claim 1, wherein the speech signal is modeled with parameters that further comprise one or more of: gain, duration, pitch, or a voiced/unvoiced distinction.

18. A medium comprising instructions that are readable and executable by a computing system, wherein the instructions configure the computing system to train and implement a speech application system, comprising configuring the computing system to:
extract features from a set of speech signals, wherein the features comprise line spectrum pairs;
evaluate differences between the frequencies of adjacent line spectrum pairs;
use the extracted features, including the differences between the frequencies of adjacent line spectrum pairs, for training one or more hidden Markov models; and
synthesize a speech signal having enhanced signal clarity in one or more portions of a frequency spectrum in which the differences between the frequencies of adjacent line spectrum pairs are indicated to be relatively small.

19. The medium of claim 18, further comprising configuring the computing system to assign at least one of: a number of line spectrum pairs, or a frame size for the synthesized speech signal, based in part on computing resources available to the computing system.

20. A computing system configured to synthesize speech, the system comprising:
means for modeling information content of speech signals using hidden Markov modeling;
means for evaluating line spectrum pairs in a linear predictive coding power spectrum representing the speech signals;
means for evaluating density of the line spectrum pairs; and
means for concentrating the information content of the speech signals in frequency ranges in which the density of the line spectrum pairs is concentrated.
